(19) United States
(12) Patent Application Publication
(10) Pub. No.: US 2014/0015750 A1
(43) Pub. Date: Jan. 16, 2014

(54) Multimode pointing device

(71) Applicant: PO HSIN CHEN, Cupertino, CA (US)

(72) Inventor: PO HSIN CHEN, Cupertino, CA (US)

(21) Appl. No.: 13/545,996

(22) Filed: Jul. 11, 2012

(51) Int. Cl. G09G 5/08

(52) U.S. Cl. 345/163

(57) ABSTRACT

A method of controlling a screen pointer (cursor) is based on the general optical computer mouse by sensing the motion of an object (306/309) on the surface of an object motion detector unit (302/303/402/502). The method can be implemented as a handheld multimode pointing device (301/401) or integrated the implemented pointing device module (502-503) in other device (501). The implemented device (101/301/401) can use in desktop pointing, handheld pointing and handwriting operation modes.

### TECHNICAL FIELD

The present invention relates to a method for adding operation functions to the general computer mouse that manipulates on the desk surface; a user interface device and some computer software perform such a method. Specifically, this invention relates to the implementation of a multimode pointing device.

### BACKGROUND ART

The touch screen is used in many handheld devices such as tablet computer, PDA, mobile phone, and so on. The touch screen provides an easy way to interact user with handheld device. The design concept of software creates some change for using the touch screen; even it effects the applications used in desktop computer system.

In desktop computer system it may be not very convenient for using the touch screen device. Because the display device (installed with touch screen) usually is a separate device in desktop computer system, when the user manipulates the touch screen, the user must stretch the arm and it is a non-ergonomic action. After a prolonged operation of the touch panel in desktop computer it may cause some physical issues in the hand and arm region of the user. And most users usually use the desktop computer mouse in a non-ergonomic environment, this also easily causes the same physical issues for the user.

As the operation of handheld touch screen device the user slides the finger or some object on the touch screen to scroll the displaying page on the display screen, the present invention propose a method that can implement a multimode computer mouse device, then the user can use the implemented device as a general desktop mouse device, a handheld pointing device or a handwriting device. When manipulating the implemented device as a handheld pointing device the user can also use an object moving on the surface of the object motion detector unit (without mechanical moving parts) of the implemented device to control some actions, such as cursor movements and display page scrolling, on the display device.

### SUMMARY OF INVENTION

The purpose of this invention is to overcome some of the drawbacks relating to the operation in touch screen device of the desktop computer system and the desktop computer mouse mentioned in the previous sections.

Hence, the first aspect of the proposal is to provide a method for implementing a multimode pointing device which can use as a general desktop computer mouse or as a handheld pointing device that facilitates the user to control the actions of display device by moving an object on the surface of proposed device, such as sliding the thumb or moving a stylus. The method includes selecting the device operation mode, sensing the object motion by an object motion detector unit (without mechanical moving parts) and determining the data of object motion on the device that is implemented according to the present invention.

### BRIEF DESCRIPTION OF DRAWINGS

Having described the invention in general terms, reference will now be made to the accompanying drawings, which are not necessarily drawn to scale, and wherein:

FIG. 1 shows schematically a block diagram of a multimode pointing device according to one embodiment of the present invention

FIG. 2 is a flow chart illustrating the number of steps of the method according to one embodiment of the present invention.

FIG. 3a shows a concept design of a multimode pointing device according to one embodiment of the first configuration of the present invention. In the first configuration the implemented pointing device comprises of two object motion detector sets in the object motion detector unit, the detector set on the device bottom is using for desktop operation and the detector set on device top is using for handheld operation.

FIG. 3b is the operation concept of handheld pointing mode for the implemented device shown in the FIG. 3a, it illustrates that a thumb is on the window surface of the top detector set of the object motion detector unit and the thumb sliding on the window surface will be able to control the screen display actions (such as cursor movement, display page scrolling) on the display device.

FIG. 3c illustrates the concept of desktop pointing mode operation for the device showing in FIG. 3a, putting the bottom of the implemented pointing device on a flat surface (such as desktop surface or a mouse pad), then it can use the device with the bottom detector set as a general desktop computer mouse.

FIG. 3d illustrates the concept of handwriting mode operation for the device showing in FIG. 3a, the device can control the actions of display device by moving an object (such as a stylus) on the window surface of the detector unit of the implemented device.

FIG. 3e illustrates another example of the handwriting mode operation for the device shown in FIG. 3a, in this example the device equips a set of ultrasonic transceivers as the top detector set, and it can detect the object (such as a stylus) motion in an area away from the implemented device.

FIG. 4 shows a concept design of a multimode pointing device according to one embodiment of the second configuration of the present invention, in this configuration the pointing device only comprises of one detector set in the object motion detector unit.

FIG. 5a shows a concept design of a multimode pointing device module according to one embodiment of the present invention, the pointing device module is integrated in a device that can use for controlling the actions of display device.

FIG. 5b illustrates another example of the concept design of the pointing device module according to one embodiment of the present invention, it shows the object motion detector unit of the implemented device module equipped with a set of ultrasonic transceivers and the detector unit is integrated on a side surface of the device that may control the pointing related actions of display device.

### DESCRIPTION OF EMBODIMENTS

The present invention now will be described more fully hereinafter with reference to the accompanying drawings, in which some examples of the embodiments of the invention are shown. Indeed, this invention may be embodied in many different forms and should not be construed as limited to the embodiments set forth herein; rather, these embodiments are provided by way of example so that this disclosure will satisfy applicable legal requirements. Like numbers refer to like elements throughout.

### EXAMPLES

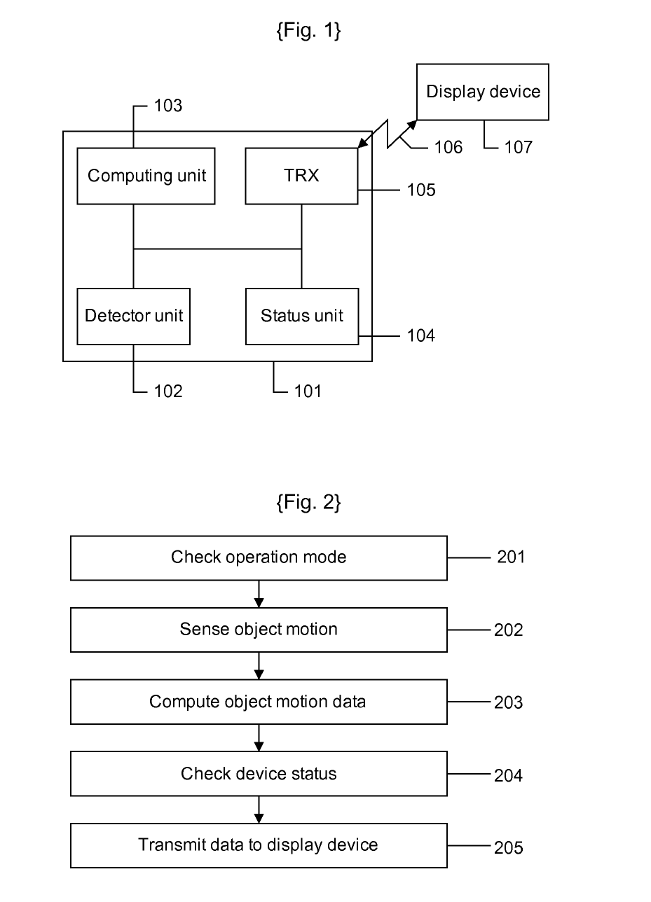

FIG. 1 illustrates schematically a multimode pointing device 101 in which an embodiment of the present invention is implemented. The device 101 is capable of communication via an air interface or cable interface 106 with a screen display device 107 such as the well known devices computer, mobile phone, electronic game device, etc. The device 101 comprises of a computing unit 103 of the object motion data, as well as input/output units in the form of an object motion detector unit 102, device status unit 104 and a data transmission unit TRX 105. The object motion detector unit 102 comprises of appropriate object movement sensing means, such as optical image detector, thermal image detector or ultrasonic transceiver configured to sense object movement by way of, e.g., a pointed stylus as well as a thumb tip moving on the window surface of detector unit. The object motion detector unit 102 may be configured to sense object motion in any one or more of different detectors. In this regard, actuation of a multimode pointing device 101 generally provides the object motion data including the moving direction, the moving speed, and the moving distance or in other ways providing sequential object coordinates or images mapping with the motion detecting area; these data combining with the device control status retrieved from the device status unit 104 will be transmitted to the display device 107 through the connection interface 106, and then the display device 107 can translate these received data to screen display actions. The method that the display device 107 how to translate the pointing data to display actions is not discussed in this regard. The device status unit 104 registers the status of the device operation elements in the device 101, such as the active operation mode of the device (setting by a specific device element) and the status of other device controlling elements (for example the status of pressing and releasing of some control buttons on the implemented device).

The multimode pointing device 101 may for example be configured as equipping the different object motion detector sets or only using one motion detector set in the object motion detector unit 102 of the said device 101. The method according to the present invention will in general reside in the form of software instructions, together with other software components necessary for the operation of the device 101. The software may control the catching of object motion by the object motion detector unit 102 and compute the object motion data in the computing unit 103, the motion data computing and data form are depending on the registered device status in the device status unit 104; at last some software in the TRX unit 105 is responsible for sending object motion data to display device 107.

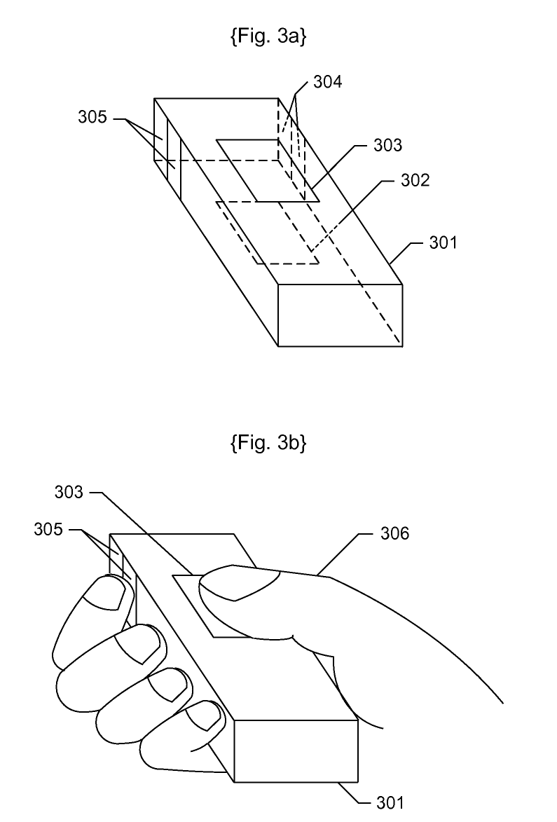

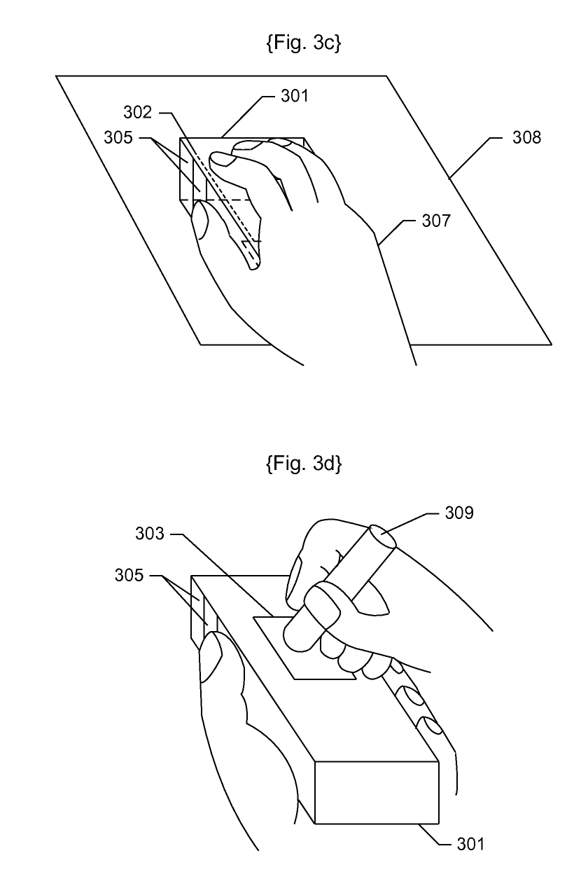

Turning now to FIGS. 2 and 3a-3e, an operation method according to one embodiment of the invention will be described in terms of a number of steps to be taken by controlling software in the device 101 described above in connection with FIG. 1.

The exemplifying method starts at a point in time when a user controls the screen display actions on the display device 107 in a way of sliding the thumb 306 on the window surface of a detector set 303 of the object motion detector unit 102 in a handheld multimode pointing device 301.

In “check operation mode” step 201, the object motion detector unit 102 checks the current operation mode of the device 301, such as the handheld pointing mode (as device 301 in FIGS. 3b), desktop pointing mode (as device 301 in FIG. 3c) or handwriting mode (as device 301 in FIGS. 3d and 3e); the operation mode information can store in the device status unit 104, and the operation mode can be set by some means: such as a 3-position switch that can set the device (101/301) to handheld, desktop or handwriting mode manually, or using a method to detect the direction of a given surface of the device (101/301) by an electronic gyro or a light sensor that can set the device (101/301) as handheld or desktop mode automatically. Depending on the operation mode the device 101/301 can change some device operation conditions, such as selecting the active detector set between the detector sets 302 and 303 in the object motion detector unit 102, adjusting the detector sensitivity of the object motion detector unit 102, determining the computation method and format of object motion data in computing unit 103, etc.

For handheld pointing mode an object moving action, e.g. thumb sliding (as the FIG. 3b), performed by a user on the window surface of detector set 303 of the object motion detector unit 102 in the multimode pointing device 301 is sensed in the “sense object motion” step 202. The sensing is realized, as discussed above, in the object movement sensing means, such as a thermal image detector set 303 in detector unit 102 can catch sequential images of the sliding thumb and send the image data to the computing unit 103, or using other type of sensors such as optical detector or ultrasonic transceiver in the object motion detector unit 102/303. When the device 101/301 is using in desktop pointing mode, currently it can equip the optical detector as the detector set 302 for sensing the motion of the pointing device itself, the device 301 will be used as a general optical computer mouse.

In “compute object motion data” step 203, the computing unit 103 of device 101/301 can be implementing as a DSP or microprocessor system loading some software to compute the object motion data. The object motion data can be translated to the screen display actions on display device 107 and the detail for controlling the screen display on the display device 107 is not discussed in this regard. The computation method of object motion data may be independent of the operation mode of device 101, such as when the device 101 is using as a computer mouse, the object motion data may contain the object moving direction, speed and distance, and when the device 101 is using in handwriting mode the object motion data may compute in the same way as the description for the computer mouse mode; herein in handwriting mode the object motion data computing method can also implement in other means such as mapping the effective detection area of the object motion detector unit 102 to a display area on the screen of the display device 107 and computing the coordinates (by computing unit 103) of pointed stylus (309 in FIG. 3d) in the object motion detecting area of detector unit 102, when these object coordinate data sending to display device 107 the application software of display device 107 can map these object coordinates as the writing trace on the mapped display area of the display device 107.

In “check device status” step 204, the computing unit 103 checks current status of device 101 from the device status unit 104 and combines the computed object motion data with the device status information. The device status unit 104 may include some user interface elements such as push buttons 304/305/404/405, rolling wheel, etc. These interface elements typically perform some control actions of screen pointer on the display device 107. There are some other sensing means that can provide the same functions of the mentioned button elements on the device 101, such as replacing the push button with touch sensing elements: for examples a small touch pad can sense finger touch, an optical sensor can sense light blocking by finger, and even may replace a button with a small area on the window surface of the detector set 303 of the object motion detector unit 102 when object is moving on or out this area, then the device 101 can regard these actions as the button pressing or releasing. An example of screen control actions in display device 107 is as: when the screen pointer is pointing at an icon on the screen display of display device 107 and a special button on the pointing device 101/301 is pressed, the display device 107 will perform some action or execute some application in display device 107; the detail of the operation in display device 107 is not discussing in this regard. Although this proposal does not discuss the detail of display device 107, the claimed pointing device 101/301 shall be able to use for the application scrolling the display page on display device 107 by stylus or thumb sliding on the surface of the pointing device.

At last in “transmit data to display device” step 205, the computed data of computing unit 103 is sending to the TRX 105 (data transmission unit), the TRX unit is connecting the display device 107 through air or cable interface 106. The data transmission can be implemented with the standard specification and format or in proprietary requirements, where the detail of TRX unit is not discussing.

A few of concept designs of the multimode pointing device 101 are showing in the FIGS. 3-5, and described as below.

### Example 1

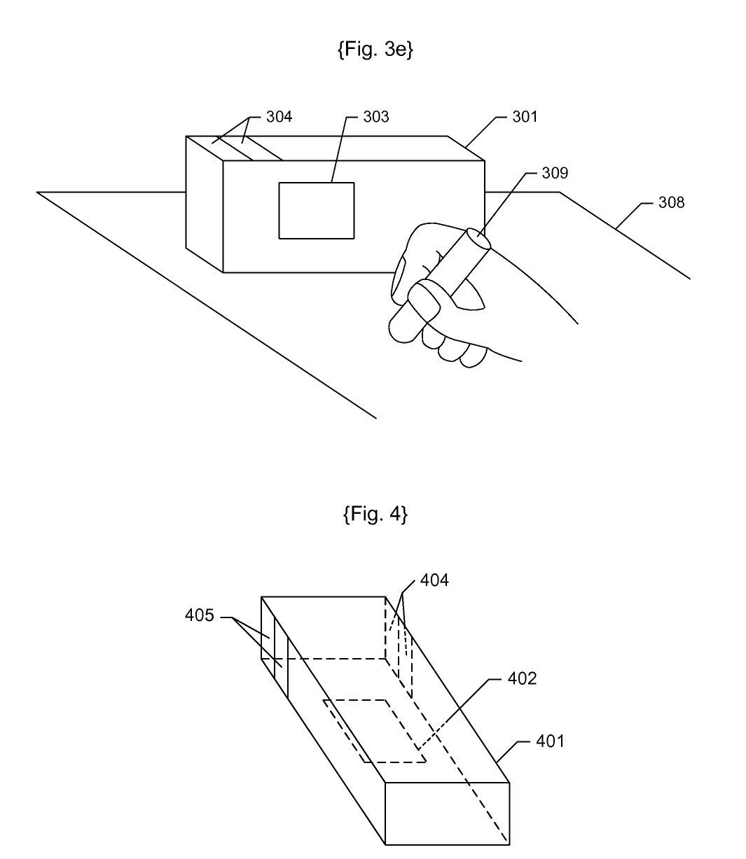

In FIG. 3a a handheld multimode pointing device 301 is showing, the device aspect includes two object motion detector sets 302/303 (the two detector sets may also install together using a single detector window as the device aspect showing in FIG. 4) and control buttons 304/305, and in FIG. 3b it illustrates the handheld pointing operation of this device 301, When setting the device as handheld pointing mode, the user can hold the device 301 in hand ergonomically and put the thumb 306 on window surface of the detector set 303, then only slides the thumb on the window area of the detector set 303, this small thumb motion can make the device 301 controls the screen pointer on the display device 107. In this example, a variety of type of motion sensors can be used as the object motion detector set 303, such as thermal detector, optical detector, ultrasonic transceiver, or touch sensor.

### Example 2

In FIG. 3c it illustrates the desktop pointing operation of the multimode pointing device 301. When put the window surface of object motion detector set 302 of device 301 on a plane area 308 (like a desktop surface or a mouse pad) as FIG. 3c and set the device operation mode to desktop pointing mode (as mentioned above the operation mode setting can perform manually or automatically), at the moment the user can move the device 301 on the plane surface by hand 307 and manipulate the device 301 as a general computer mouse. In this example the object motion detector set 302 can implement with an optical detector (as the detector used for general optical computer mouse).

### Example 3

In FIG. 3d it shows the usage of a multimode pointing device 301 setting the operation mode in the handwriting mode, as the figure showing the user can perform hand writing or painting on the window surface of the motion detector set 303 with an object like a stylus 309. In handwriting mode the device 301 can compute the object motion data as that in the pointing mode or use other way as mapping the object motion detection area to a display area on the display device 107, this mapping method is dependent on the application and the detail is not discussing in this regard. In the handwriting usage the object motion detector unit 102 may be required to equip a high resolution object motion sensor or a high resolution image sensor for detecting the small moving object. The stylus design may also depend on the type of the used object motion sensor, such as to thermal detector the stylus needs a design to increasing the temperature of stylus tip, for ultrasonic sensor the stylus should be able to reflect the ultrasonic wave strongly.

### Example 4

In FIG. 3e it shows the usage of a multimode pointing device 301 (showing in FIG. 3a) setting the operation mode as the handwriting mode, in this example the top object motion detector set is comprising of a set of ultrasonic transceivers, and as the figure showing put a side surface of the said device 301 on a plane surface, then the device can perform hand writing or painting on the plane surface 308 in front of the detector set 303 with an object like a stylus 309. Usually the ultrasonic transceivers can detect the object motion in a far distance; that is the object moving detection is not limited on the window surface of detector set 303 and the hand writing and painting can perform in a large area.

### Example 5

In FIG. 4 it shows a handheld multimode pointing device 401 with the second configuration of the proposed invention, the device aspect includes only one object motion detector set (as the detector set 402) and control buttons 404/405. In this device 401 it can use a single detector set with appropriate motion sensor in the object motion detector unit 102 to replace the two motion detector sets using in device 301 (showing as FIG. 3a). The device 401 can be also operated with the three modes mentioned in above examples. To reverse the device 401 making the window surface of object motion detector set 402 as the top surface of the device 401, then the user can manipulate the device 401 in handheld pointing mode or handwriting mode as the FIG. 3d. When putting the window surface of object motion detector set 402 on a plane surface, the device 401 can operate in desktop pointing mode as FIG. 3c. In this example the optical image sensor (as the sensor of general optical computer mouse) is an appropriate object motion sensor for the one detector set configuration of the claimed invention in this document.

### Example 6

When the claimed device is built as a handheld multimode pointing device with two detector sets (like the device showing in FIG. 3), one detector set of the said device can implement with an acceleration sensor set, or add the acceleration sensor set as the third detector set. The user can hold the said pointing device (equipping with acceleration sensor set) in hand, and move the device by swinging user's arm rapidly. The said device can detect the accelerating motion of the device itself by the acceleration sensor and determine the motion data like motion direction and motion acceleration, then the device sends the data to display device (107), the display device can translate the data to its actions, and the detail of behalves of display device 107 is not discussing in this document.

### Example 7

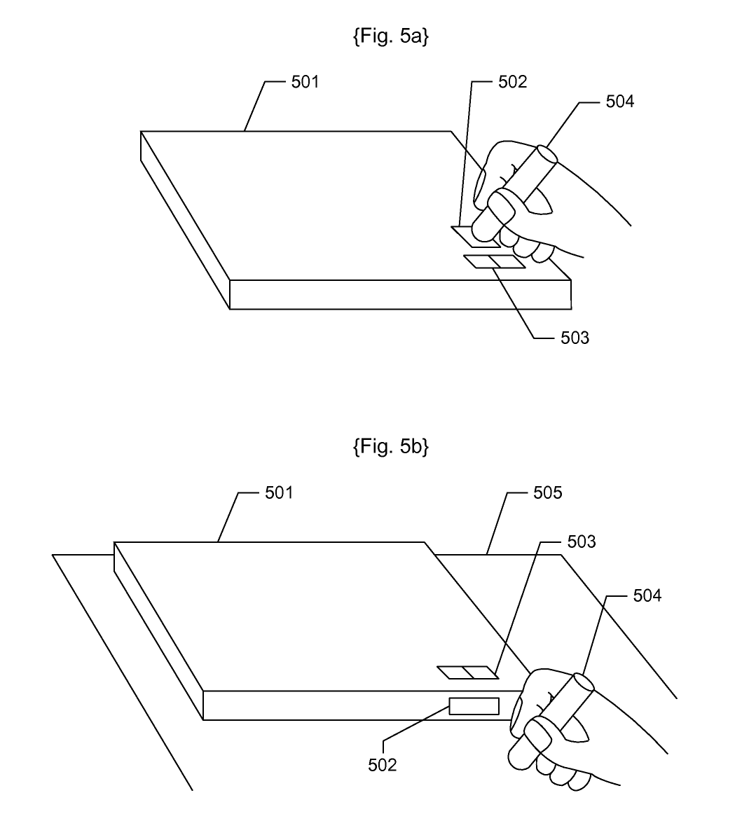

In FIG. 5 it shows a multimode pointing module (showing as detector unit 502 and elements of device status unit 503) integrates in a device that may control the actions of screen display in display device 107. As the FIG. 5a it illustrates to install the object motion detector unit 502 on the top surface of host device 501 (such as a keyboard, display device, tablet PC, etc.) and can manipulate the pointing device module on the window surface of the object motion detector unit 502. In FIG. 5b the object motion detector unit 502 is equipping with a set of ultrasonic transceivers and the module detector unit 502 is integrated on a side surface of host device 501. In this configuration the pointing module (502/503) can operate as: in pointing mode the user can move an object like a stylus 504 on a plane surface 505 in front of the object motion detector unit 502 and the object motion can control the screen pointer on the display device 107. When using the implemented module in handwriting mode, the user can write and paint with a stylus 504 in a large plane area 505 before the detector set 502.

### Example 8

Refer to the schematic design figure (FIG. 1) of the claimed multimode pointing device, the device contains a “Status Unit”, this unit comprises of some elements for controlling the pointing device operation, one of the elements is used for setting the operation mode of the implemented pointing device, this element can implement in many different methods, herein it describes two methods: the first one using a 3-position switch as the said element it can use each switch position to set the pointing device operating in one mode of the three operation modes manually; in the second method the said device can equip an electronic gyro (gyro can detect its direction) or a light sensor (when the installing surface of light sensor is used as bottom of pointing device and put on the desk surface the light sensor will be blocked, so it can decide the surface direction) as the said element that can determine the direction of a given surface of the said pointing device, such as the window surface of detector unit on the implemented pointing device 401, depending on the surface direction the said pointing device can set its operation mode as desktop mode (window surface is as the bottom of pointing device) or handheld mode (window surface is as the top of pointing device) automatically, in this way it may need another part (like a 2-position switch) to help setting the pointing mode and handwriting mode, then the second method can set the three modes completely.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

1. A method based on the general desktop computer mouse can comprise a multimode pointing device with an object motion detector unit (without mechanical moving parts in the detector unit) comprising of two detector sets which are used in different operation mode separately, the device can manipulate in three modes as:
in desktop pointing mode putting the window surface of the active detector set on the desk surface the device can use as a general computer mouse,
in handheld pointing mode the user can hold the device in hand and use it as a pointing device by moving an object on the window surface or the detectable area of the active detector set,
in handwriting mode the device is used as handwriting input device, the user can write on the window surface or the detectable area of the active detector set with an object like a stylus or other tools,
then from the object motion detected by the detector unit the device can compute the object motion data and transmit the data to display device through air or cable interface, the display device can translate the object motion data to the actions in the display device.

2. The method according to claim 1, wherein the object motion detector unit described in claim 1 can be configured by replacing the two object motion detector sets with a single appropriate type of object motion detector set, in this configuration the implemented pointing device can manipulate in the three modes with the same ways mentioned in claim 1.

3. The method according to claim 1, wherein the object motion detector sets of the detector unit described in claim 1 can be implemented in a variety of types of detectors, such as optical detector, thermal detector, ultrasonic transceiver, touch sensor and so on, the two detector sets can be implemented with same type or different type of detectors, for example equipping an optical detector as one detector set that can use for the operation of desktop pointing mode and installing the other detector set with different type of detector (like thermal detector, touch sensor or ultrasonic transceiver) for the operation of handheld pointing mode; the above mentioned detectors all can also use for the operation of handwriting mode.

4. The method according to claim 1, wherein one of the object motion detector sets of the detector unit described in claim 1 can be also implemented with other category of sensors that can sense the rapid movement of the implemented device itself. An example of this kind of sensor is the acceleration sensor, also know as the accelerometer. The user can hold the device implemented with acceleration sensor set and move the said device rapidly (like swinging the user's arm), then the said device can detect its acceleration motion and can determine the device motion data and send the data to display device.

5. The method according to claim 1, wherein an element of the implemented pointing device is used for setting the operation mode mentioned in claim 1, the said element can comprise of different kind of parts and manipulate in different ways to set the operation modes of the said device, for example, a multi-position switch can set the operation mode manually, and an electronic gyro or a light sensor can set the operation mode automatically, the detail of the said element can refer to “check operation mode” step 201″ and example 8.

6. The method according to claim 1, wherein the implemented multimode pointing device module can be integrated in a device that provides the pointing related functions, for example the said pointing device module can be integrated in keyboard, display device, computer tablet device, mobile phone, TV set, remote controller, watch type device, camera device, electronic game device, and so on.
